(19) United States
(12) Patent Application Publication
(10) Pub. No.: US 2005/0074728 A1
(43) Pub. Date: Apr. 7, 2005

(54) Floral arranging teaching aids and methods of use

(76) Inventors: Mary J. Dark, Shreveport, LA (US); Rebecca B. Seiden, Shreveport, LA (US)

Correspondence Address: John M. Harrison, 2139 E. Bert Kouns, Shreveport, LA, 71105, US

(21) Appl. No.: 10/882,413

(22) Filed: Jul. 2, 2004

Related U.S. Application Data
(60) Provisional application No. 60/503,783, filed on Sep. 22, 2003.

(51) Int. Cl. A01G 5/00

(52) U.S. Cl. 434/93

(57) ABSTRACT

Floral arranging teaching aids and methods of use include a translucent, transparent, solid or penetrable medium base member of selected shape and size and optionally having one or more visible cores or targets therein, with optional openings extending from the surface through the base member and toward or to the target. Multiple real or simulated flower stems, the latter typically consisting of a dowel and an enlarged top segment or portion which is color-coded to simulate the various flowers, are inserted into the openings or into the solid penetrable medium, or through a chart wrapped around the base member and having correspondingly color-coded prints thereon that may align with corresponding openings, to indicate where the dowels are to be inserted in the openings or in the penetrable medium. Arrangement of the real or simulated flower stems in selected or correspondingly color-coded prints in the penetrable medium or through the color-coded base member openings, facilitates instruction in the art of flower arranging.

### CROSS-REFERENCE TO RELATED APPLICATIONS

This application claims the benefit of and incorporates by reference prior filed copending U.S. Provisional Application Ser. No. 60/503,783, Filed Sep. 22, 2003.

### SUMMARY OF THE INVENTION

This invention relates to floral arranging teaching aids and methods of use and in one embodiment, to a floral arranging teaching aid which is characterized by a transparent or translucent block or structure of selected size and shape, with a flat or otherwise stable bottom and one or more visible cores or targets therein and having multiple base member stem openings, each extending toward or to the target. Various charts may be provided for wrapping around the base member, which charts are typically constructed of thin plastic or tissue paper having chart stem dots or prints in selected locations, some or all of which prints may be color-coded and superimposed on corresponding ones of the base member stem openings. Multiple real or simulated flower stems are extended through the dots or prints into the underlying openings to create a real or simulated floral arrangement. The simulated flower stems are each typically characterized by a dowel having an enlarged top portion which is typically color-coded to match the respective color-coded chart stem prints and are used to simulate selected flowers. This simulation is completed by inserting the respective stem dowels of the simulated flower stems through the corresponding color-coded chart stem prints and into the underlying base member stem openings to support the respective simulated flower stems in the base member at selected angles and depths. When the desired combination of simulated flower stems is inserted in the corresponding color-coded chart stem prints, real or artificial flowers can be correspondingly arranged in a vase or in a container provided with a penetrable medium such as an expanded foam, including “wet foam”, or an alternative stem-supporting medium, including dry expanded foam, using an optional underlying floral diagram as additional decoration.

In another embodiment the floral arrangement teaching aids include a penetrable medium such as an expanded dry or wet foam base of selected consistency, shape and size and the respective simulated flower stems are typically sharpened and inserted through correspondingly-shaped color-coded chart stem prints applied to the base. Alternatively, the base can be selectively marked and the simulated flower stems inserted directly therein at the marked locations. Accordingly, flower arranging techniques can be taught using the base member and the various charts shaped for wrapping around the base member and positioning over the penetrable medium, including expanded foam, such as dry or wet foam, which charts have corresponding, typically color-coded chart stem prints thereon at selected locations for receiving correspondingly color-coded simulated and real or artificial flower stems.

### BRIEF DESCRIPTION OF THE DRAWINGS

The invention will be better understood by reference to the accompanying drawings, wherein:

FIG. 1 is a perspective view of a transparent or translucent base member cube fitted with multiple base member stem openings which are drilled or molded to contact or approach a visible core target located inside the base member;

FIG. 2 is a typical flexible chart provided with multiple chart stem prints thereon, some of which chart stem prints are color-coded and all of which typically coincide with corresponding ones of the base member stem openings illustrated in FIG. 1 when the chart is applied to the base member;

FIG. 3 is a perspective view of typical simulated flower stems characterized by stem dowels and simulated color-coded flowers on the ends thereof;

FIG. 4 is a perspective view of a second flexible chart having all color-coded stem prints thereon which match the respective color codings on the simulated flowers located on the simulated flower stems illustrated in FIG. 3;

FIG. 5 is a perspective view of the chart illustrated in FIG. 4, shaped and folded to fit over the base member illustrated in FIG. 1, with the respective color-coded chart stem prints superimposed on the corresponding underlying base member stem openings located in the base member;

FIG. 6 is a perspective view of the base member and chart combination illustrated in FIG. 5 with various simulated flower stems inserted through correspondingly color-coded stem prints on the chart and into the underlying base member stem openings in the base;

FIG. 7 is a perspective view of a completed simulated flower arrangement with a simulated flower stem inserted through each one of the corresponding color-coded chart stem prints in the chart;

FIG. 8 is a top view of a typical floral diagram, upon which is placed a vase or flower container, typically provided with “wet foam” for receiving a chart and real or artificial flowers and arranging the flowers in the configuration of the floral arrangement illustrated in FIG. 7;

FIG. 9 is a perspective view of the floral diagram illustrated in FIG. 8, with a chart positioned over the “wet foam” for matching the real or artificial flower stems and the respective chart stem prints on the chart;

FIG. 10 is a perspective view of a bridal floral arrangement teaching aid, more particularly illustrating an expanded foam penetrable medium supported by a base having a handle for gripping by a bride or bridesmaid, with a flexible chart stretched over the underlying expanded foam and color-coded to receive various simulated flower stems;

FIG. 11 is a perspective view, partially in section, of an alternatively shaped handle for the expanded foam base illustrated in FIG. 10;

FIG. 12 is a typical flexible chart having a flexible elastic band around the periphery thereof for fitting over the underlying expanded foam medium illustrated in FIG. 10;

FIG. 13 is a perspective view of an expanded foam substrate fitted with the flexible chart illustrated in FIG. 12;

FIG. 14 is a perspective view of typical non-color coded simulated flower stems for insertion in the expanded foam substrate through the flexible section chart as illustrated in FIG. 10;

FIG. 15 is an exploded view of the bridal floral arrangement teaching aid and selected ones of the simulated flower stems illustrated in FIG. 10;

FIG. 16 is an exploded view of a ring floral arrangement teaching aid provided with an expanded foam ring which receives a correspondingly-shaped ring chart provided with color-coded chart stem prints for receiving a collection of simulated flower stems in an alternative simulated teaching aid arrangement;

FIG. 17 is an exploded view of a rectangular floral arrangement teaching aid, including an expanded foam rectangle for receiving a correspondingly-shaped rectangle chart having color-coded chart stem prints for receiving the color-coded or generic simulated flower stems in a simulated flower arrangement;

FIG. 18 is an exploded view of an expanded foam cone fitted with a cone chart having color-coded chart stem prints for receiving the corresponding simulated flower stems and creating a cone-shaped simulated flower arrangement;

FIG. 19 is a perspective view of the cone floral arrangement teaching aid illustrated in FIG. 18, more particularly illustrating placement of the cone chart on the underlying expanded foam cone;

FIG. 20 is a perspective view of a sphere floral arrangement teaching aid, more particularly illustrating an expanded foam sphere provided with a shaped sphere chart fitted with color-coded chart stem prints for receiving the various simulated flower stems to create an alternative simulated flower arrangement;

FIG. 21 is a perspective view of the sphere floral arrangement teaching aid illustrated in FIG. 20, more particularly illustrating the sphere chart in place over the expanded foam sphere for receiving the respective simulated flower stems at the corresponding color-coded chart stem print positions; and

FIG. 22 is a cube floral arrangement teaching aid constructed of expanded foam or other penetrable medium and including cube markings representing color-coded chart stem locations for receiving corresponding simulated flower stems and creating an alternative cube simulated flower arrangement.

### DESCRIPTION OF THE PREFERRED EMBODIMENTS

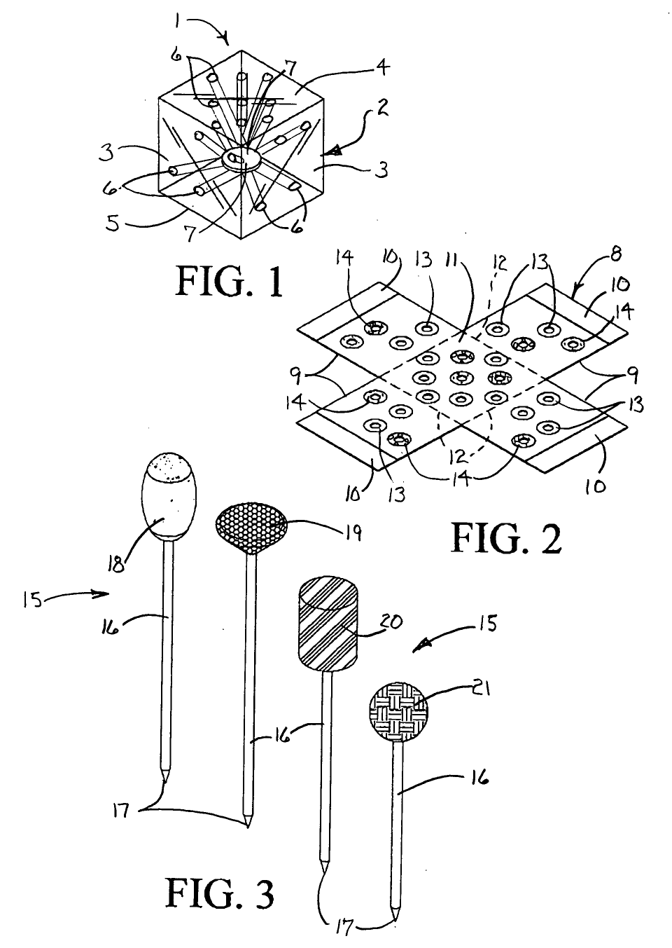

Referring initially to FIG. 1 of the drawings in a preferred embodiment a cube floral arranging teaching aid 1 of this invention includes a base member 2, which is transparent or at least translucent, and includes base member sides 3, a base member top 4 and a flat base member bottom 5, typically in the configuration of a cube, as indicated. It will be appreciated by those skilled in the art that the base member 2 can be constructed in any geometrical shape, including a polygon, trapezoid, pyramid and the like, in non-exclusive particular, so long as the base member 2 is constructed of a transparent or translucent material and has a flat bottom for stability. A visible core or target 7 is provided in the interior of the base member 2 and may be characterized by a disc, sphere or the like, preferably having a distinctive color so as to be clearly visible in the base member 2. More than one target 7 can be provided in the base member 2, depending upon the desired size thereof. Multiple base member stem openings 6 are also provided in the base member 2 and extend from the respective surfaces of the base member sides 3 and the base member top 4 downwardly, angling toward or to the target(s) 7. The base member stem openings 6 may extend to the target or targets 7 or they may project toward the target(s) 7 as desired, for purposes which will be hereinafter further described. The base member stem openings 6 may either be drilled in the base member 2 toward the target(s) 7 or may be shaped in the base member 2 at selected depths and spacing during a molding process or processes known to those skilled in the art.

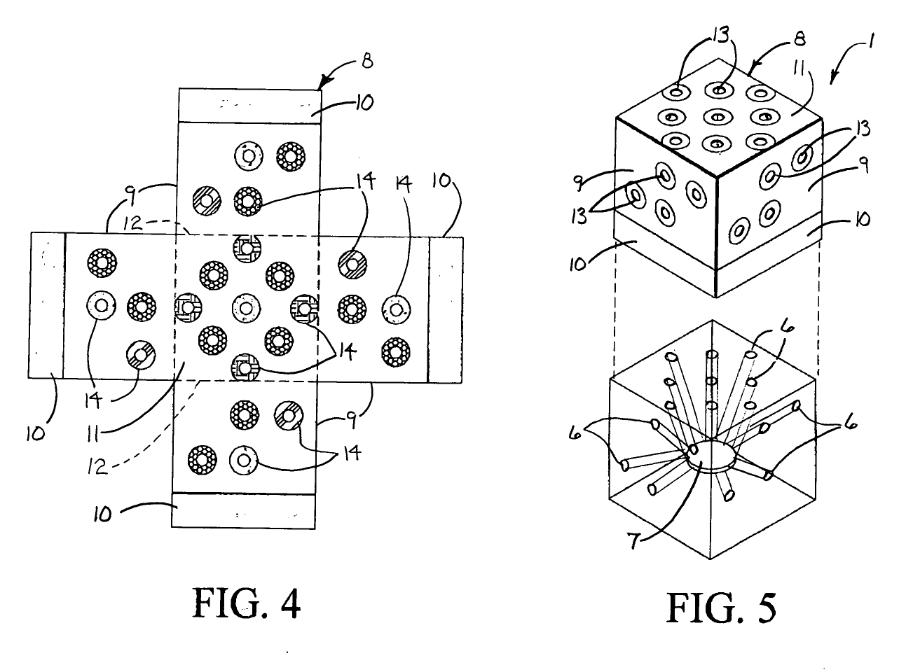

Referring now to FIGS. 2, 4 and 5 of the drawings a cube chart 8 is illustrated, having chart sides 9, each of which typically includes a side margin 10 on the extending end thereof. The cube chart 8 is typically constructed of thin plastic or paper, such as tissue paper and further includes a chart top 11, with fold lines 12 provided along the periphery of the chart top 11 to define the chart sides 9. Multiple chart stem prints 13 are provided on the chart sides 9 and the chart top 11 and, as further illustrated in FIG. 2, and at least some of the chart stem prints 13 may include color-coded chart stem prints 14, for purposes which will be further hereinafter described. As in the case of the cube chart 8 illustrated in FIG. 2, the flexible cube chart 8 illustrated in FIG. 4 is characterized by chart sides 9, having side margins 10, a chart top 11 and fold lines 12 that define the respective chart sides 9. In each case, the color-coded and non-color-coded chart stem prints 13 illustrated in FIG. 2 and the all color-coded chart stem prints 14 illustrated in FIG. 4 are spaced-apart and arranged on the respective chart sides 9 and chart top 11, such that folding and taping or gluing of the cube chart 8 over the base member 2 as illustrated in FIG. 5 of the drawings causes each of the mixed lot of chart stem prints 13, as well as the all color-coded chart stem prints 14, as the case may be, to be superimposed over a corresponding one of the base member stem openings 6 in the base member 2. In each case, the side margins 10 extend downwardly from the respective chart sides 9 and typically around the bottom area of the base member 2 to simulate a flower container or vessel, as further illustrated in FIG. 5 of the drawings.

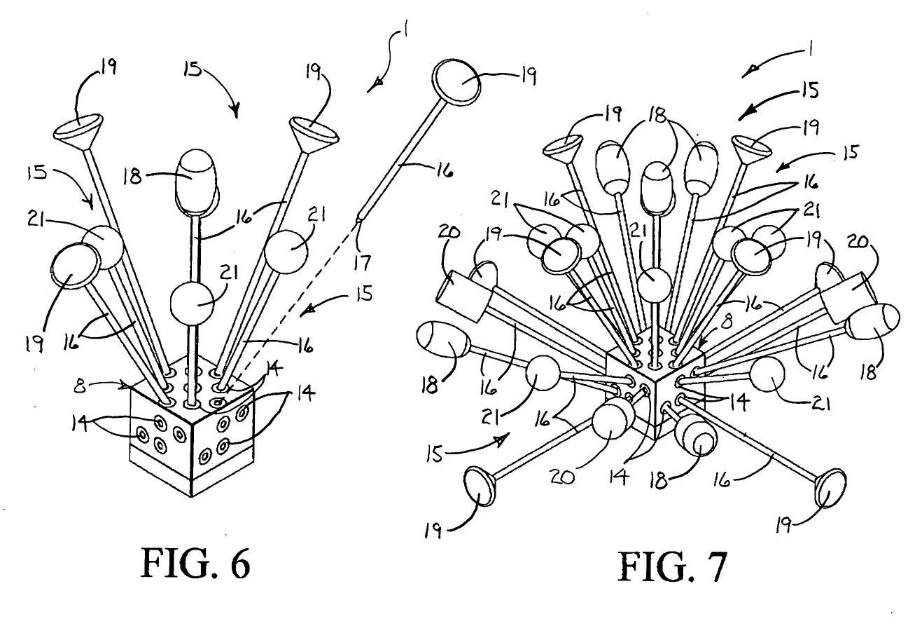

Referring now to FIGS. 3, 6 and 7 of the drawings in a preferred embodiment of the invention simulated flower stems 15 are provided, each of which include a stem dowel 16 of selected length, preferably having a dowel point 17 at one extending end and a first simulated flower 18, a second simulated flower 19, a third simulated flower 20 and a fourth simulated flower 21 of selected shape and color provided at the opposite end of the stem dowel 16, respectively (FIG. 3). In another preferred embodiment of the invention the first simulated flower 18, second simulated flower 19, third simulated flower 20 and the fourth stimulated flower 21 provided on each of the stem dowels 16 are shaped in a different configuration and are color-coded to match the color-coded chart stem prints 14 illustrated in FIGS. 4 and 5 of the drawings. Accordingly, referring now to FIGS. 6 and 7 of the drawings, various flower arranging patterns can be simulated by inserting each respective stem dowel 16 of the corresponding first simulated flower 18, second simulated flower 19, third simulated flower 20 and fourth simulated flower 21 through either the chart stem prints 13 illustrated in FIG. 2 or the color-coded chart stem prints 14 illustrated in FIGS. 2, 4 and 5, such that each stem dowel 16 extends into the corresponding underlying base member stem openings 6 in the base member 2 and are supported therein as illustrated in FIGS. 6 and 7. Insertion of each respective stem dowel 16 into a selected one of the non-color-coded chart stem prints 13 on a cube chart 8 facilitates random orientation of the respective first simulated flower 18, second simulated flower 19, third simulated flower 20, and fourth simulated flower 21 to create a simulated flower arrangement of selected diversity. Likewise, insertion of each respective stem dowel 16 into the corresponding color-coded chart stem prints 14 on a cube chart 8 illustrated in FIGS. 2, 4 and 5 of the drawings creates a preselected color-coded flower arrangement, since the first simulated flower 18, second simulated flower 19, third simulated flower 20 and fourth simulated flower 21 are designed to match the corresponding color-coded chart stem prints 14 in the cube chart 8. In like manner, the stems of real flowers may be color-coded or the stems of flowers having various colors inserted in the corresponding color-coded chart stem prints 14 to create an actual flower arrangement.

It will be appreciated that the possible combinations of the first simulated flower 18, second simulated flower 19, third simulated flower 20 and fourth simulated flower 21 in the respective chart stem prints 13 and color-coded chart stem prints 14 of the respective cube charts 8 facilitate extensive variation in the number of simulated flower arrangements that can be accomplished using the cube floral arranging teaching aid 1, simply by using various charts having different combinations of the chart stem prints 13 and color-coded chart stem prints 14 on the cube charts 8.

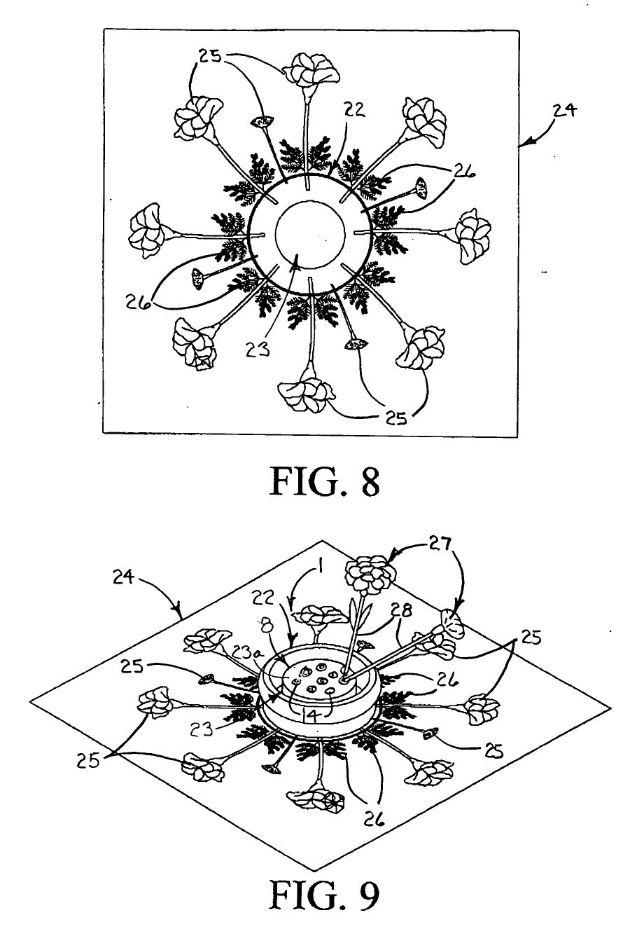

Referring now to FIGS. 8 and 9 of the drawings, under circumstances where it is desired to develop a live or artificial flower arrangement of varying color and/or type in a flower receptacle 22 of selected size and shape, which includes a mass of a penetrable medium of selected consistency such as an expanded dry or wet foam 23 for receiving and holding the various arranged flower stems 28 of the arranged flowers 27, a selected pre-printed floral diagram 24 is initially positioned beneath the flower receptacle 22, as illustrated. A chart, typically having the same or a similar print configuration as the cube chart 8 covering the base member 1, is then positioned over the top of the expanded dry or wet foam penetrable medium 23 (FIG. 9). The arranged flower stems 28 of the respective arranged flowers 27 are then inserted through the respective chart stem prints 13 and color-coded stem prints 14 on the cube chart 8, into the expanded dry or wet foam 23, typically in alignment with the diagram flower simulations 25 provided on the floral diagram 24, and in accordance with the orientation of the first simulated flower 18, second simulated flower 19, third simulated flower 20 and the fourth simulated flower 21 illustrated in FIG. 7 of the drawings. Simulated greenery 26 may also be placed in proper arrangement around the arranged flowers 27, as further illustrated in the floral diagram 24. The stems of real flowers can also be inserted in the color-coded chart stem prints 14, as described above.

It will be appreciated from a consideration of the drawings and the above, that applicants' floral arranging teaching aids in the above-described embodiments are characterized by diversity and simplicity in the teaching of floral arranging, in that they may include a transparent or translucent base member 2 of selected size, shape and number of base member openings 6, each extending toward or to the target 7 in the base member 2, or a penetrable medium such as an expanded foam substrate or base for receiving the respective simulated flower stems 15. Furthermore, the desired number of first simulated flower 18, second simulated flower 19, third simulated flower 20 and fourth simulated flower 21 in any desired combination, may be provided on corresponding stem dowels 16 to create the number of simulated flower stems 15 deemed necessary to teach the desired flower arrangement. It will be further appreciated that each chart, such as the cube chart 8, may be constructed of a shape and size to correspond to the selected base member 2, with the respective chart stem prints 13 and/or color-coded chart stem prints 14 illustrated in FIGS. 2 and 4 of the drawings, respectively, corresponding to the underlying base member stem openings 6 in the correspondingly shaped base member 2. Moreover, the provision of chart stem prints 13, illustrated in FIG. 2 having no color coding, along with the color-coded chart stem prints 14, facilitates ingenuity and creativity in designing a variety of floral arrangements having a selected number and variety of real flower stems, as well as the simulated flower stems 15 placed in various positions in the chart stem prints 13 and extending into the corresponding base member stem openings 6, for this purpose.

It will be further appreciated by those skilled in the art that the base member 2 can be used as a base for insertion of the respective simulated flower stems 15 directly without the use of a cube chart 8 or the like, under circumstances where it is desired to create a flower arrangement of selected color diversity without the guidance provided by the color-coded chart stem prints 14.

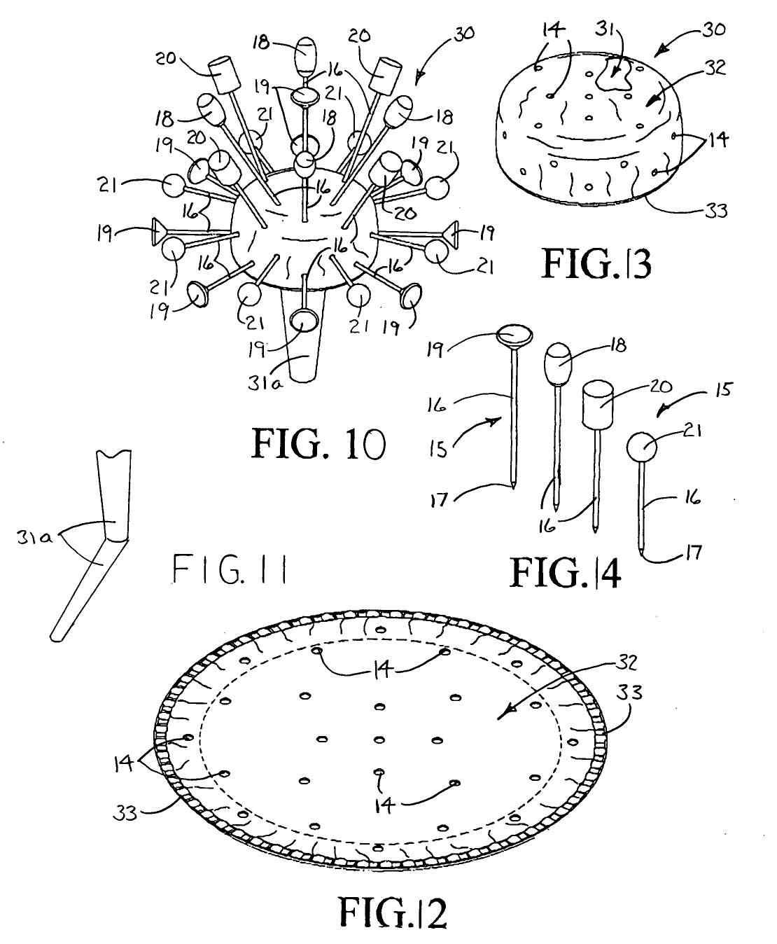

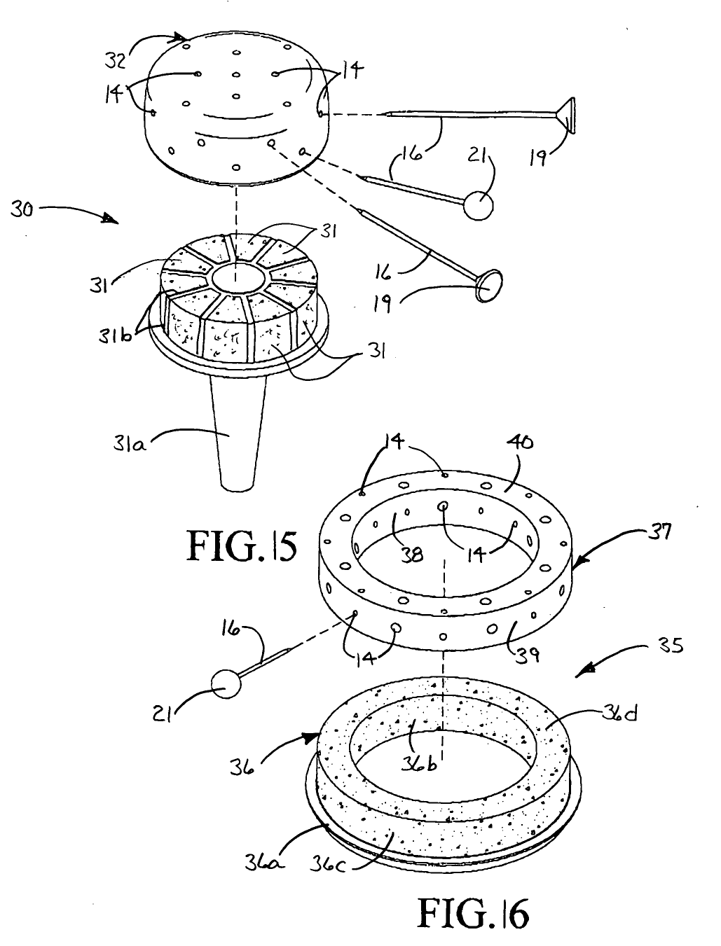

Referring now to FIGS. 10-15 of the drawings in an alternative preferred embodiment of the invention a bridal floral arrangement teaching aid is generally illustrated by reference numeral 30 and includes one or more expanded foam or alternative penetrable medium sections 31, embedded or mounted on a base 31b, from which extends a handle 31a (FIG. 15). In an alternative embodiment of the invention the handle 31a may be bent as illustrated in FIG. 11, to facilitate a more secure positional grasp by a bridesmaid or bride. As further illustrated in FIGS. 10, 12, 13 and 15, a flexible, typically thin plastic section chart 32 is typically provided with a drawstring or an elastic band 33 around the periphery thereof (FIG. 12) and also includes multiple color-coded and selectively spaced and arranged chart stem prints 14 for receiving selected ones of either the non-color-coded simulated flower stems 15, having stem dowels 16 and dowel points 17 as illustrated in FIG. 14 or the color-coded simulated flower stems 15 illustrated in FIG. 3, as desired. Accordingly, selected ones of the simulated flower stems 15 can be inserted in the corresponding color-coded chart stem prints 14 as illustrated in FIG. 10 to simulate a typical flower arrangement and various combinations of the simulated flower stems 15 can be used in other desired combinations of the color-coded chart stem prints 14 to create a simulated flower arrangement of desired appeal. Referring again to FIG. 15 of the drawings it will be appreciated that the expanded foam sections 31 can be constructed or characterized by either a dry or wet expanded foam material, or an alternative penetrable medium, according to the knowledge of those skilled in the art, for receiving the respective stem dowels 16 of the corresponding simulated flower stems 15.

Referring now to FIG. 16 of the drawings the ring floral arranging teaching aid 35 is generally illustrated by reference numeral 35 and includes an expanded foam or alternative penetrable medium ring 36, typically characterized by a plastic ring base 36a for support and fitted with a correspondingly-shaped, flexible or molded ring chart 37. The expanded foam ring 36 includes an inner ring base surface 36b, an outer ring base surface 36c and a top ring base surface 36d, as further illustrated in FIG. 16. In like fashion, the inner ring chart 37 is characterized by an inner ring chart surface 38 that fits over the inner ring base 36b of the ring chart 37, an outer ring chart surface 39 that engages the outer ring base surface 36c and a top ring chart surface 40 that fits over the corresponding top outer ring base surface 36d of the ring chart 37. Accordingly, it will be appreciated by those skilled in the art that when the ring chart 37 is fitted over the correspondingly-shaped expanded foam ring 36, the respective color-coded chart stem prints 14 located on the ring chart 37 will serve to guide the insertion of the corresponding simulated flower stems 15, illustrated in FIGS. 3 and 14, respectively, wherein the corresponding stem dowels 16 are projected through the respective color-code chart stem prints 14 to create a ring arrangement teaching aid 35 complete with the simulated flower stems 15 as illustrated in FIG. 10 with respect to the bridal floral arrangement teaching aid 30.

Referring now to FIG. 17 of the drawings a rectangular floral arrangement teaching aid 42 is illustrated and includes a typically expanded foam rectangle 43 of selected size and having an inner rectangle surface 43a, an outer rectangle surface 43b and a top rectangular surface 43c, respectively. A molded or flexible rectangle chart 46 is similarly shaped and includes an inner rectangle chart surface 47, an outer rectangle chart surface 48 and a top rectangle chart surface 49 which correspond, respectively, to the inner rectangle surface 43a, the outer rectangle surface 43b and the top rectangle surface 43c of the expanded foam rectangle 43. Accordingly, when the expanded foam rectangle 43 receives the corresponding rectangle chart 46, the respective simulated flower stems 15 illustrated in FIGS. 3 and 14 can be inserted through the corresponding color-coded chart stem prints 14 provided on the rectangle chart 46, into the underlying expanded foam rectangle 43 and a simulated flower arrangement of selected design can be created.

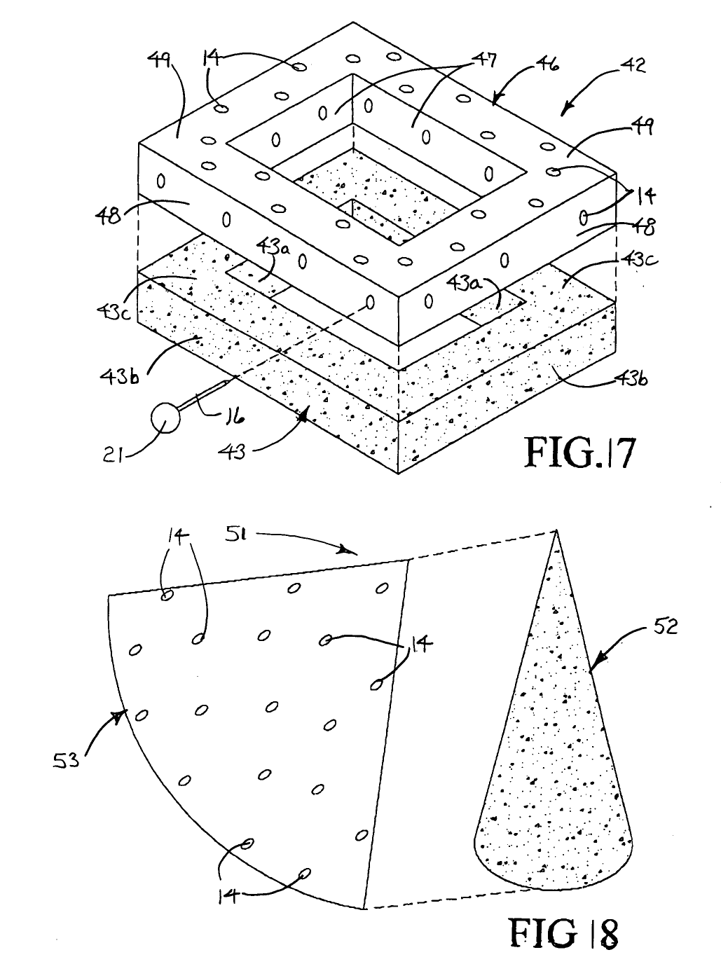

Referring now to FIGS. 18 and 19 of the drawings in another preferred embodiment of the invention a cone floral arrangement teaching aid 51 is illustrated and includes an expanded foam cone 52 of selected size and proportion, fitted with a flexible or molded cone chart 53, such that the cone chart 53 is wrapped around or placed over the expanded foam cone 52 to typically define a chart seam 53a, as illustrated in FIG. 19. The cone chart 53 is provided with multiple color-coded chart stem prints 14 as further illustrated in FIGS. 18 and 19, for receiving the corresponding stem dowels 16 of simulated flower stems 15, illustrated in FIGS. 3 and 14 and creating a simulated floral arrangement shaped in the configuration of a cone, as illustrated in FIG. 19.

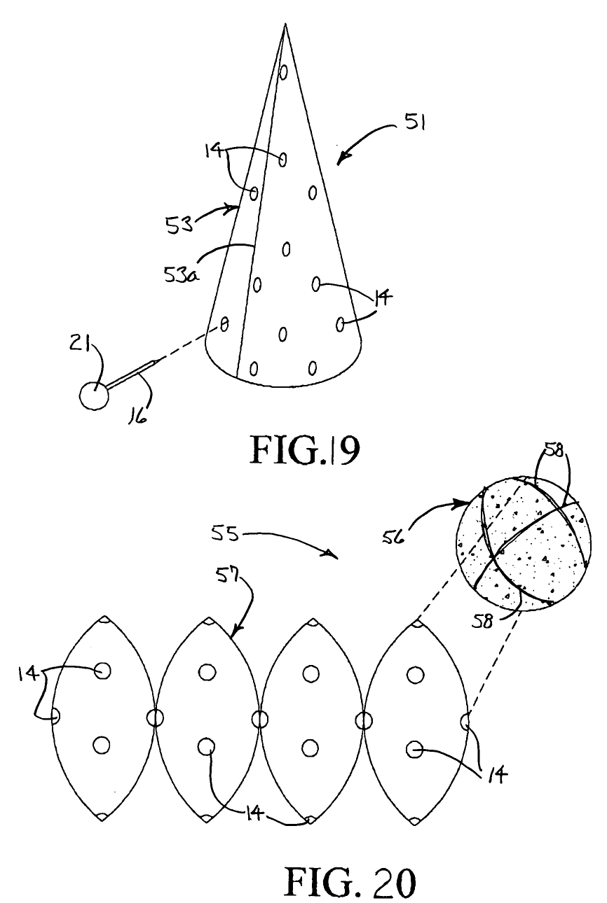

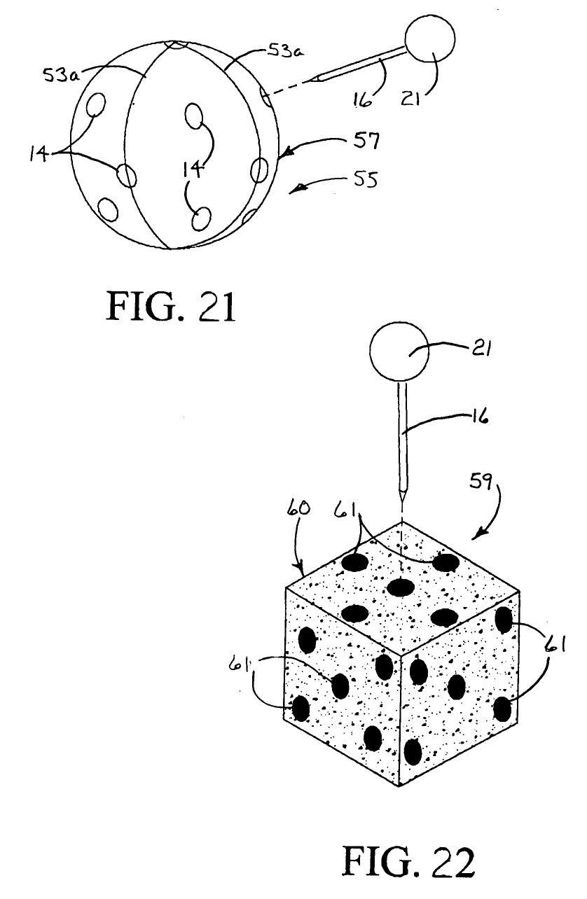

Referring now to FIGS. 20 and 21 of the drawings in another preferred embodiment of the invention a sphere floral arrangement teaching aid 55 is illustrated and is characterized by a typically expanded foam sphere 56 of selected size, having a sphere chart 57 constructed for covering the expanded foam sphere 56, as illustrated in FIG. 21 of the drawings. The sphere chart 57 is further provided with color-coded chart stem prints 14 which guide a user in inserting the respective stem dowels 16 of the simulated flower stems 15, illustrated in FIGS. 3 and 14, respectively, through the sphere chart 57 and into the expanded foam sphere 56 to create a simulated flower arrangement of selected diversity. In another aspect of this invention the expanded foam sphere 56 may be provided with sphere markings 58, as further illustrated in FIG. 20, such that the respective stem dowels 16 are inserted in the expanded foam sphere 56 at the intersection of the respective sphere chart markings 58 and/or in the open spaces approximately equally spaced from the intersections of the sphere markings 58, to create a simulated flower arrangement without the necessity of providing a sphere chart 57.

Referring now to FIG. 22 of the drawings a cube floral arrangement teaching aid 59 is provided and includes an expanded foam cube 60 having cube markings 61, which typically, but not necessarily, correspond to random markings, for purposes of illustration. It will be appreciated by those skilled in the art that the respective cube markings 61 may be placed in any desired pattern on each face of the expanded foam cube 60 for receiving the various stem dowels 16 of the simulated flower stem 15 illustrated in FIGS. 3 and 14, as desired.

It is understood that the floral arrangement teaching aids illustrated in FIGS. 10-22 are illustrative, in that the respective penetrable medium members and corresponding charts can be shaped in any desired configuration and any combination and spacing of chart stem prints for insertion of the respective stem dowels 16, as desired.

Accordingly, while the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A floral arranging teaching aid comprising a substantially transparent base member; at least one visible target provided in said base member; at least one stem opening provided in said base member, said stem opening extending at least toward said target; and at least one flower stem inserted in said stem opening, wherein said flower stem is supported in said base member.

2. The floral arranging teaching aid of claim 1 wherein said at least one stem opening comprises a plurality of stem openings disposed in selected locations in said base member.

3. The floral arranging teaching aid of claim 2 wherein said at least one flower stem comprises a plurality of flower stems inserted in said stem openings, respectively.

4. The floral arranging teaching aid of claim 3 wherein said flower stems and at least some of said stem openings are color-coded.

5. The floral arranging teaching aid of claim 1 wherein said at least one flower stem comprises at least one simulated flower stem having a dowel for insertion in said at least one stem opening and a simulated and color-coded flower provided on said dowel for simulating a selected flower.

6. The floral arranging teaching aid of claim 5 wherein said at least one stem opening comprises a plurality of stem openings disposed in selected locations in said base member for receiving said dowel and mounting said at least one simulated flower stem in said stem openings, respectively.

7. The floral arranging teaching aid of claim 6 wherein at least some of said stem openings are color-coded to match a corresponding one of said simulated and color-coded flower.

8. A floral arranging teaching aid comprising a base member; at least one stem opening provided in said base member; a chart provided on said base member; at least one chart stem print provided on said chart, said chart stem print positioned substantially over said stem opening; respectively; and at least one flower stem inserted through said chart stem print and into said stem opening, wherein said flower stem is supported in said base member.

9. The floral arranging teaching aid of claim 8 wherein said at least one stem opening comprises a plurality of stem openings and said at least one chart stem print comprises a plurality of color-coded chart stem prints positioned over said stem openings and said at least one flower stem comprises a plurality of color-coded flower stems to match said color-coded chart stem prints, respectively.

10. The floral arranging teaching aid of claim 9 wherein each of said color-coded flower stems comprises a simulated flower stem having a dowel for insertion through said chart stem prints and into said stem openings, respectively, and a simulated and color-coded flower provided on said dowel for simulating a selected flower and matching said color-coded chart stem prints.

11. A floral arrangement teaching aid comprising a penetrable medium of selected consistency, size and shape and a plurality of simulated flower stems for extending into said penetrable medium in a selected pattern and defining a simulated floral arrangement.

12. The floral arrangement teaching aid of claim 11 wherein said simulated flower stems each comprises a dowel for insertion in said penetrable medium in said selected pattern and a selected simulated flower provided on said dowel for defining said simulated floral arrangement.

13. The floral arrangement teaching aid of claim 11 comprising a chart substantially conforming to said penetrable medium and a selected number of chart prints provided on said chart for receiving said simulated flower stems.

14. The floral arrangement teaching aid of claim 13 wherein said penetrable medium comprises an expanded foam material, at least selected ones of said chart prints are color-coded chart prints and said simulated flower stems each comprises a dowel for insertion through corresponding ones of said chart prints and said color-coded chart prints, respectively, into said expanded foam material and comprising a color-coded simulated flower provided on said dowel for matching said chart prints and said color-coded chart prints and defining said simulated floral arrangement.

15. A method of teaching floral arranging comprising the steps of providing a substantially transparent base member having at least one visible target therein and at least one opening extending through said base member at least toward said target, and extending the stem of at least one flower into said opening to define a floral arrangement.

16. The method according to claim 15 comprising the steps of providing a chart on said base member, said chart having at least one color-coded print thereon, said color-coded print substantially corresponding to said opening in said transparent base member, and extending the stem of the flower through said color-coded print and into said opening.

17. The method according to claim 16 comprising the steps of providing a plurality of openings in said base member, providing a plurality of color-coded prints on said chart, said color-coded prints substantially corresponding to said openings, respectively, and providing a plurality of simulated color-coded flower stems for insertion in said color-coded prints and into said openings, respectively, and defining the floral arrangement.

18. The method according to claim 17 comprising the steps of providing a plurality of non-color-coded prints on said chart, said color-coded prints and said non-color-coded prints substantially corresponding to selected ones of said openings in said base member, respectively, and extending said simulated color-coded flower stems through said color-coded prints and said non-color-coded prints and into said openings, respectively, to define the floral arrangement.

19. The method according to claim 16 wherein said base member comprises a penetrable medium of selected consistency, size and shape and comprising the steps of providing a floral diagram of selected design; placing a flower container on said floral diagram; placing the penetrable medium in said flower container; positioning said chart on the penetrable medium, said chart having at least some of said color-coded prints thereon; and extending said stem through said color-coded prints into the flower-supporting penetrable medium.

20. The method according to claim 19 comprising the step of adding simulated greenery to said floral diagram.

21. A method of teaching floral arranging comprising the steps of providing a penetrable medium of selected consistency, size and shape; providing a chart on said penetrable medium, said chart having at least one color-coded print thereon; and providing at least one color-coded simulated plant stem for insertion in said color-coded print to define a simulated floral arrangement.

22. The method according to claim 21 wherein said at least one color-coded print comprises a plurality of color-coded prints provided on said penetrable medium in a selected pattern; said at least one color-coded simulated plant stem comprises a plurality of dowels for insertion in said color-coded prints and said penetrable medium in said selected pattern and comprising the step of providing color-coded simulated flowers on said dowels, respectively, for matching said color-coded prints and defining said simulated flower arrangement.
